(19) United States
(12) Patent Application Publication
(10) Pub. No.: US 2011/0106309 A1
(43) Pub. Date: May 5, 2011

(54) Humanoid robot and control method of controlling joints thereof

(75) Inventors: Bok Man Lim, Seoul (KR); Kyung Shik Roh, Seongnam-si (KR); San Lim, Suwon-si (KR); Myung Hee Kim, Suwon-si (KR)

(73) Assignee: SAMSUNG ELECTRONICS CO., LTD., Suwon-si (KR)

(21) Appl. No.: 12/926,164

(22) Filed: Oct. 28, 2010

(30) Foreign Application Priority Data
Oct. 30, 2009 (KR) 10-2009-104630

(51) Int. Cl. B25J 9/00

(52) U.S. Cl. 700/250; 901/1

(57) ABSTRACT

Disclosed herein are a humanoid robot and a control method thereof. The humanoid robot controls robot parts performing main motions having high relevance with respect to a commanded action to the humanoid robot such that these robot parts move along optimized motion trajectories generated through motion optimization in consideration of robot dynamics, and controls robot parts performing remaining motions having low relevance with respect to the commanded action such that these robot parts move along predetermined motion trajectories corresponding to the commanded action, thereby simplifying optimization of whole body motions of the humanoid robot while performing the commanded action maximally similarly to a real human action.

### CROSS-REFERENCE TO RELATED APPLICATIONS

This application claims the benefit of Korean Patent Application No. 2009-0104630, filed on Oct. 30, 2009 in the Korean Intellectual Property Office, the disclosure of which is incorporated herein by reference.

### BACKGROUND

1. Field

Embodiments relate to a humanoid robot which shortens time to optimize whole body motions of the humanoid robot, and a control method thereof.

2. Description of the Related Art

In general, humanoid robots are robots which have the same appearance and shape as those of humans, walk with two legs, and manipulate objects with two arms.

The humanoid robots, which have a joint system similar to that of humans, have been vigorously developed so as to provide various services as substitutes for humans in human working and living spaces.

In order to perform various whole body motions like humans, actuators installed on many joints of a robot need to be effectively controlled simultaneously, and natural whole body motions similar to human actions may be generated through this control.

A humanoid robot includes a plurality of links and a plurality of joints. The humanoid robot performs an action commanded by a user, such as an action of changing a posture, a walking action, an action of throwing an object, or an action of kicking a ball, by adjusting the respective joints (i.e., a rotating angle of a link relative to another link).

In order to effectively perform a rapid and dynamic action, such as an action of lifting a heavy object, an action of throwing an object, or an action of kicking a ball, robot dynamics is considered when whole body motions of the robot are planned. Thereby, motions of the respective joints are optimized, and thus the humanoid robot may assume a balanced and stable posture.

In case of a rapid action, such as an action of lifting an arm or an action of kicking a ball, if robot dynamics is not considered when whole body motions of the robot are generated, although specifications of the actuators are sufficient, it is difficult to achieve a desired motion. In order to solve this problem, data obtained by capturing human motions are used. However, in this case, kinematical and dynamic discordance between the robot and human cause a long time to convert the data into input satisfying robot dynamics.

Therefore, when whole body motions of the robot to perform a designated action commanded to the humanoid robot are generated, optimization, in which optimum joint trajectories are searched by repeatedly varying parameters, i.e., motion variables of all joints of the humanoid robot in consideration of robot dynamics, was conventionally performed.

However, since the optimization is performed with respect to all the joints of the humanoid robot, the number of the joints used as optimization variables is increased, and thus an optimization search space is enlarged. Thereby, a long time is taken for the optimization and results obtained from the optimization are unreliable.

### SUMMARY

Therefore, it is one aspect of at least one embodiment to provide a humanoid robot in which robot parts performing main motions of an action commanded to the humanoid robot are controlled using motion trajectories generated through motion optimization in consideration of robot dynamics and robot parts performing remaining motions are controlled using predetermined motion trajectories corresponding to the commanded action, and a control method thereof.

Additional aspects will be set forth in part in the description which follows and, in part, will be obvious from the description, or may be learned by practice of the invention.

The foregoing and/or other aspects are achieved by providing a humanoid robot includes an input unit to receive an action command input from a user, a control unit generate a first control signal to to control robot parts performing main motions of an action commanded according to the action command input through the input unit using optimized motion trajectories generated through motion optimization in consideration of robot dynamics, and to generate a second control signal to control robot parts performing remaining motions using predetermined motion trajectories corresponding to the commanded action, and a driving unit to drive respective joints of the humanoid robot according to the first and second control signals of the control unit.

Each of the robot parts may be any one of joints, links, and end-effectors, or combinations thereof.

Each of the motion trajectories may be at least one of joint trajectories, link trajectories, and end-effector trajectories.

The control unit may include a command interpretation unit to interpret the action command input through the input unit and to recognize the robot parts performing the main motions having high relevance with respect to the commanded action and the robot parts performing remaining motions having low relevance with respect to the commanded action, respectively.

The control unit may further include a motion trajectory generation unit to perform optimization as to the robot parts performing the main motions in consideration of robot dynamics to generate the optimized motion trajectories of the robot parts performing the main motions, and to generate the predetermined motion trajectories of the robot parts performing the remaining motions corresponding to the commanded action.

The control unit may further include a storage unit to divisionally store robot parts performing main motions having high relevance with each of actions to be commanded and robot parts performing remaining motions having low relevance with each of actions to be commanded according to action commands, and to store predetermined motion trajectories corresponding to the action commands.

The control unit may further include a motion command unit to output a motion command for the robot parts performing the main motions to move along the optimized motion trajectories, generated by the motion trajectory generation unit, to the driving unit to control operation of the driving unit, and to output a motion command for the robot parts performing the remaining motions to move along the predetermined motion trajectories, generated by the motion trajectory generation unit corresponding to the commanded action, to the driving unit to control operation of the driving unit.

The control unit may perform the motion optimization by searching for optimum motion trajectories while repeatedly varying motion parameters in consideration of robot dynamics as to the robot parts performing the main motions.

The joints to perform the main motion of the commanded action and a velocity profile of a center of gravity of the humanoid robot may be parameterized using parameters representing a start time and an end time.

The optimized motion trajectories may be generated by optimizing angles, velocities and accelerations of respective joints used in performing main motions of the commanded action so as to generate a maximum velocity of an end-effector.

The foregoing and/or other aspects are achieved by providing a control method of a humanoid robot includes receiving an action command input from a user, interpreting the input action command, and determining first robot parts performing main motions of a commanded action and second robot parts performing remaining motions of the commanded action, and controlling the first robot parts using optimized motion trajectories generated through motion optimization in consideration of robot dynamics, and controlling the second robot parts performing the remaining motions using predetermined motion trajectories corresponding to the commanded action.

Each of the first robot parts and the second robot parts may be any one of joints, links, and end-effectors, or combinations thereof.

The recognition may be achieved using first robot parts and second robot parts which are divisionally stored in advance according to action commands.

The predetermined motion trajectories may be stored in advance so as to correspond to the commanded action according to action commands.

The motion optimization may be performed by searching for optimum motion trajectories while repeatedly varying motion parameters in consideration of robot dynamics as to the first robot parts.

The foregoing and/or other aspects are achieved by providing a humanoid robot, including: an input unit to receive an action command input from a user; a controller comprising: a command interpretation unit interpreting the action command input to the input unit and determining robot parts performing main motions having a high relevance compared with all motions of the robot with respect to the commanded action and robot parts performing remaining motions having a low relevance compared with all motions of the robot with respect to the commanded action, a motion trajectory generation unit generating, optimized motion trajectories of the robot parts performing the main motions and generating predetermined motion trajectories of the robot parts performing the remaining motions, and a motion command unit outputting a first motion command for the robot parts performing the main motions to move along the optimized motion trajectories and second motion command for the robot parts performing the remaining motion to move along the predetermined motion trajectories; and a driving unit receiving the first and second motion commands and driving respective joints of the humanoid robot according to the first and second motion commands.

The foregoing and/or other aspects are achieved by providing a control method for a robot, including: receiving an action command input from a user; interpreting the action command input to the input unit and determining robot parts performing main motions having a high relevance compared with all motions of the robot with respect to the commanded action and robot parts performing remaining motions having a low relevance compared with all motions of the robot with respect to the commanded action; generating optimized motion trajectories through motion optimization in consideration of robot dynamics for the robot parts determined to perform the main motions; accessing a storage unit to obtain predetermined motion trajectories stored in advance for the robot parts determined to perform the remaining motion; and driving respective joints of the robot according to the optimized motion trajectories and the predetermined motion trajectories.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view illustrating an external appearance of a humanoid robot in accordance with at least one embodiment;

FIG. 2 is a view illustrating main joint structures of the humanoid robot in accordance with at least one embodiment;

FIG. 3 is a schematic control block diagram of the humanoid robot in accordance with at least one embodiment;

FIGS. 4A and 4B are graphs respectively illustrating velocity profiles of arm joints before and after application of an optimization method only to arm motions, which are main motions of a throwing action, in the humanoid robot in accordance with at least one embodiment;

FIGS. 5A and 5B are views illustrating throwing actions before and after application of the optimization method only to the arm motions, which are the main motions of the throwing action, in the humanoid robot in accordance with at least one embodiment;

FIG. 6 is a view illustrating continuous actions obtained by applying the optimization method only to the arm motions, which are the main motions of an action of throwing a ball, in the humanoid robot in accordance with at least one embodiment;

FIG. 7 is a view illustrating continuous actions obtained by applying the optimization method only to leg motions, which are main motions of an action of kicking a ball, in the humanoid robot in accordance with at least one embodiment; and

FIG. 8 is a flow chart illustrating a control method of the humanoid robot in accordance with the embodiment.

### DETAILED DESCRIPTION

Reference will now be made in detail to at least one embodiment, examples of which are illustrated in the accompanying drawings, wherein like reference numerals refer to like elements throughout.

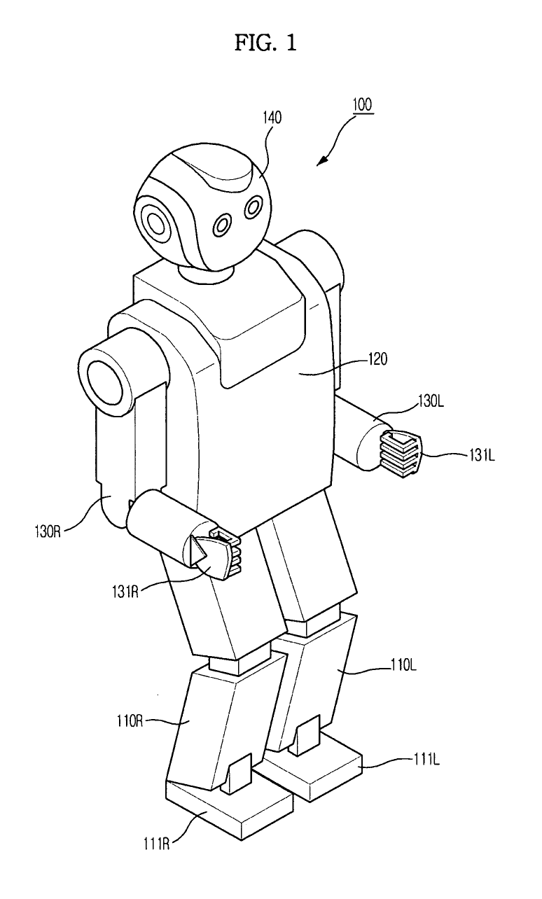

FIG. 1 is a perspective view illustrating an external appearance of a humanoid robot in accordance with at least one embodiment.

As shown in FIG. 1, the humanoid robot in accordance with at least one embodiment which is a biped walking robot 100 with two legs 110R and 110L in the same manner as a human, includes a torso 120, two arms 130R and 103L and a head 140 connected to the upper portion of the torso 120, and feet 111R and 111L and hands 131R and 131L respectively connected to front ends of the two legs 110R and 110L and the two arms 130R and 130L. Here, R and L respectively represent a right side and a left side of the robot 100.

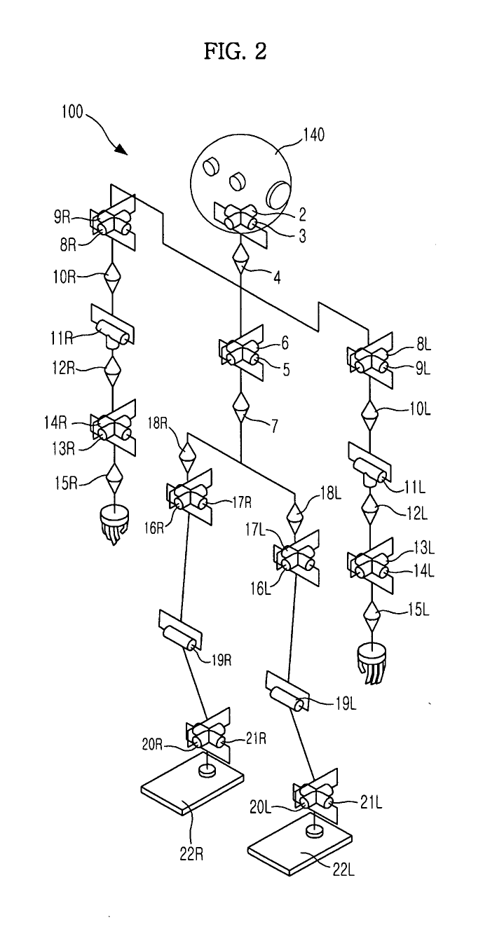

FIG. 2 is a view illustrating main joint structures of the humanoid robot of FIG. 1.

As shown in FIG. 2, a neck joint to support the head 140 includes a neck joint roll shaft 2, a neck joint pitch shaft 3, and a neck joint yaw shaft 4, and thus may move in the roll direction (the direction of the X-axis), in the pitch direction (in the direction of the Y-axis), and in the yaw direction (in the direction of the Z-axis).

The two arms 130R and 130L respectively include shoulder joints, elbow joints, and wrist joints such that parts of the robot 100 corresponding to shoulders, elbows, and wrists are rotatable.

The shoulder joints of the two arms 130R and 130L respectively include shoulder joint roll shafts 8R and 8L, shoulder joint pitch shafts 9R and 9L, and shoulder joint yaw shafts 10R and 10L, and thus may move in the roll direction (the direction of the X-axis), in the pitch direction (in the direction of the Y-axis), and in the yaw direction (in the direction of the Z-axis).

The elbow joints of the two arms 130R and 130L respectively include elbow joint pitch shafts 11R and 11L and elbow joint yaw shafts 12R and 12L, and thus may move in the pitch direction (in the direction of the Y-axis) and in the yaw direction (in the direction of the Z-axis).

The wrist joints of the two arms 130R and 130L respectively include wrist joint roll shafts 13R and 13L, wrist joint pitch shafts 14R and 14L, wrist joint yaw shafts 15R and 15L, and thus may move in the roll direction (the direction of the X-axis), in the pitch direction (in the direction of the Y-axis), and in the yaw direction (in the direction of the Z-axis).

The torso 120 includes a torso roll shaft 6, a torso pitch shaft 5, and a torso yaw shaft 7, and thus may move in the roll direction (the direction of the X-axis), in the pitch direction (in the direction of the Y-axis), and in the yaw direction (in the direction of the Z-axis).

The two legs 110R and 110L respectively include leg joint roll shafts 16R and 16L, leg joint pitch shafts 17R and 17L, and leg joint yaw shafts 18R and 18L, and thus may move in the roll direction (the direction of the X-axis), in the pitch direction (in the direction of the Y-axis), and in the yaw direction (in the direction of the Z-axis). The two legs 110R and 110L respectively further include knee joint pitch shafts 19R and 19L, and thus may move in the pitch direction (the direction of the Y-axis). The two legs 110R and 110L respectively further include ankle joint roll shafts 20R and 20L and ankle joint pitch shafts 21R and 21L, and thus may move in the roll direction (the direction of the X-axis) and in the pitch direction (in the direction of the Y-axis). The feet may be represented by base 22R and 22L.

Natural and skilled human actions are acquired through constant exertions for a considerable time. For example, a child's action of throwing a ball or swinging a bat is imperfect. A golf beginner's action of swinging a golf club is the same. These actions have been mastered through repetition and study for several years. Such a process is referred to as a process of efficiently and harmoniously controlling all the joints respectively having degrees of freedom. As a result of the process, optimization of most actions with respect to specific physical ranges is achieved.

From a control point of view, slow motions, which were initially performed by the feedback of a sensor, such as a visual sensor, are modified into optimized motions programmed in advance through learning. Therefore, optimization through selection of a specific objective function is a process of achieving the learning of actions, which were carried out for a long time, in a short time.

Particularly, rapid and dynamic actions, such as a jumping action and a kicking action, are highly influenced by the total weight of the robot 100 and the specification of actuators. However, in order to reduce energy and cost consumption of the robot 100, although the specifications of the actuators are not increased, a desired dynamic performance of the robot 100 may be achieved. For this purpose, motion optimization in consideration of robot dynamics needs to be achieved to maximize the dynamic performance of the robot 100. An optimized motion may be used as a feed-forward input in robot control.

The reason that most motion optimization based on robot dynamics is carried out off-line is that robot dynamic calculation requires a long time. Particularly, in the case of a humanoid robot having multiple joints having at least 3 degrees of freedom, time to optimize motions is increased geometrically. That is, when all joint inputs of a multiple degree of freedom system, such as the humanoid robot, serve as optimization parameters, and robot dynamics and a confined condition objective function are formulated, it takes a long time to optimize motions, and the motions may not be optimized in some cases.

For this reason, a process of performing motion optimization in which an optimization search space is effectively reduced to shorten a motion optimization time and increase reliability is important.

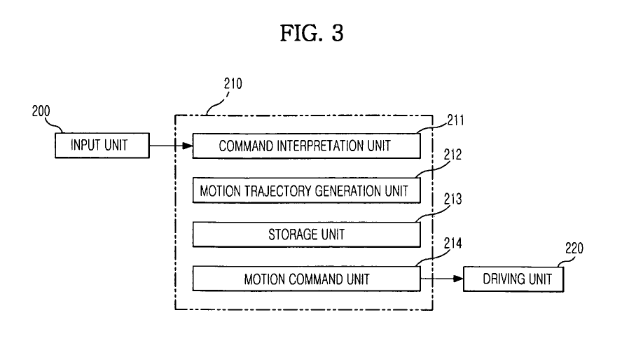

FIG. 3 is a schematic control block diagram of the humanoid robot in accordance with at least one embodiment.

As shown in FIG. 3, the humanoid robot 100 in accordance with at least one embodiment includes an input unit 200 to receive an action command input from a user, a control unit 210 to perform overall control of the robot 100 according to the action command input through the input unit 200 by generating control signals, and a driving unit 220 to drive the respective joints of the humanoid robot 100 according to the generated control signals of the control unit 210.

The control unit 210 includes a command interpretation unit 211, a motion trajectory generation unit 212, a storage unit 213, and a motion command unit 214.

The command interpretation unit 211 interprets the action command input through the input unit 200, and recognizes robot parts performing main motions having high relevance with respect to the commanded action and robot parts performing remaining motions having low relevance with respect to the commanded action, respectively.

The motion trajectory generation unit 212 performs optimization as to the robot parts performing the main motions in consideration of robot dynamics to generate optimized motion trajectories of the robot parts performing the main motions, and generates predetermined motion trajectories of the robot parts performing the remaining motions corresponding to the commanded action. Here, each of the motion trajectories is any one of joint trajectories, link trajectories, end-effector (for example, fingertip and toe tip) trajectories.

The storage unit 213 divisionally stores robot parts performing main motions having high relevance with respect to each of actions to be commanded and robot parts performing remaining motions having low relevance with respect to each of actions to be commanded according to the actions to be commanded, and stores the predetermined motion trajectories respectively corresponding to the actions to be commanded.

The motion command unit 214 outputs a motion command for the robot parts performing the main motions to move along the optimized motion trajectories, generated by the motion trajectory generation unit 212, to the driving unit 220 to control operation of the driving unit 220, and outputs a motion command for the robot parts performing the remaining motions to move along the predetermined motion trajectories, generated by the motion trajectory generation unit 212 corresponding to the commanded action, to the driving unit 220 to control operation of the driving unit 220.

Therefore, the humanoid robot 100 in accordance with at least one embodiment controls robot parts (e.g., specific body parts, combinations of joints, combinations of links, and combinations of joints and links) performing main motions having high relevance with respect to the action commanded to the humanoid robot 100 such that these robot parts move along the optimized motion trajectories generated through motion optimization in consideration of robot dynamics, and controls robot parts performing remaining motions having low relevance with respect to the commanded action such that these robot parts move along the predetermined motion trajectories corresponding to the commanded action, thereby simplifying optimization of whole body motions of the humanoid robot 100, while performing the commanded action maximally similarly to a real human action.

In one example, if the humanoid robot 100 performs an action of throwing an object, motion optimization in consideration of robot dynamics is performed only as to the arms, and thus motion trajectories are generated and applied to the arms, and predetermined motion trajectories corresponding to the throwing action are applied to remaining robot parts, such as the legs, the waist, and the torso. Therefore, since motion trajectories only as to the arm motions which are main motions of the throwing action are generated in consideration of robot dynamics by repeatedly varying parameters so that the throwing action is similar to a real human throwing action, optimization of whole body motions of the humanoid robot 100 may be simplified and the action of the humanoid robot 100 may become maximally similar to a real human action.

In another example, if the humanoid robot 100 performs an action of kicking a ball, motion optimization in consideration of robot dynamics is performed only as to the legs, and thus motion trajectories are generated and applied to the legs, and predetermined motion trajectories corresponding to the kicking action are applied to remaining robot parts, such as the arms and the torso. Therefore, since motion trajectories only as to the leg motions which are main motions of the kicking action are generated in consideration of robot dynamics by repeatedly varying parameters so that the kicking action is similar to a real human kicking action, optimization of whole body motions of the humanoid robot 100 may be simplified and the action of the humanoid robot 100 may become maximally similar to a real human action.

The motion optimization in consideration of robot dynamics only as to the robot parts performing the main motions of the commanded action in the humanoid robot 100 in accordance with at least one embodiment is started with parameterization of joints to perform the main motions of the commanded action and a velocity profile of the center of gravity of the robot 100 using parameters representing a start time and an end time.

Thereafter, motion trajectories are generated by a random initial value. That is, when the start time and the end time of the motion are set randomly, trajectories of the respective joints and the center of gravity are generated according to the set start time and end time.

After the trajectories of the respective joints and the center of gravity are generated, a value of a predetermined objective function having limited conditions is calculated.

Thereafter, it is confirmed whether a convergence condition of an objective function calculating routine is satisfied. If the value of the objective function having limited conditions differs from a value of the objective function calculated in an earlier routine by less than a designated amount, it is confirmed that the convergence condition of the objective function calculating routine is satisfied.

If it is confirmed that the convergence condition of the objective function calculating routine is satisfied, a start time t0 and an end time tf to minimize the value of the objective value having the limited conditions are confirmed.

Velocity profiles of joints required to generate optimized motion trajectories and the center of gravity are set using the start time t0 and the end time tf to minimize the value of the objective value having the limited conditions, thereby generating the optimized motion trajectories.

On the other hand, if it is confirmed that the convergence condition of the objective function calculating routine is not satisfied, trajectories are generated by other initial values until the convergence condition is satisfied, thereby calculating the value of the objective function.

For example, if a start posture and a final posture of a commanded action (for example, an action of kicking a ball or throwing a ball) are given, the control unit 210 optimizes joint trajectories to generate the maximum velocity of the end-effector (for example, the fingertip or the toe tip). The optimization of the joint trajectories refers to generation of joint trajectories in which angles, velocities, and accelerations of the respective joints are optimized so as to generate the maximum velocity of the end-effector. For this purpose, the control unit 210 is operated as follows.

First, when a start time and an end time of a commanded action are given randomly, the control unit 210 generates motion trajectories of the respective joints and the center of gravity (COG) according to the start time and the end time of the commanded action. If the motion trajectories of the respective joints and the center of gravity (COG) are generated, joint angles, joint velocities, and joint accelerations of the humanoid robot 100 according to time may be extracted. Therefore, the humanoid robot 100 may perform motions according to the extracted joint angles, joint velocities, and joint accelerations.

Further, the control unit 210 uses a bell-type velocity profile as a velocity profile in a working space or a joint space, and parameterizes velocity profiles of the respective joints using the start time and the end time, thus being capable of determining optimum control timing of the respective joints. The velocity profile is formed in a bell shape, and represents a variation of velocity according to time.

Secondly, the control unit 210 calculates the objective function predetermined to maximize the velocity of the end-effector when the motion is performed. The control unit 210 calculates the value of the objective function, and, if the convergence condition for optimization is not satisfied, generates motion trajectories by other initial values until the convergence condition is satisfied, and thus calculates the value of the objective function. On the other hand, if the convergence condition for optimization is satisfied, the control unit 210 stops repetition of optimization. Here, if a variation of the value of the objective function is less than a random value, the optimum convergence condition of the objective function is satisfied.

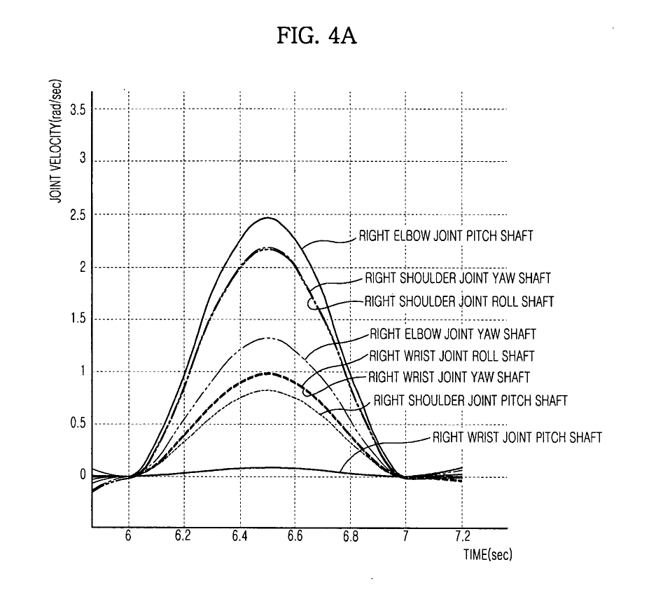

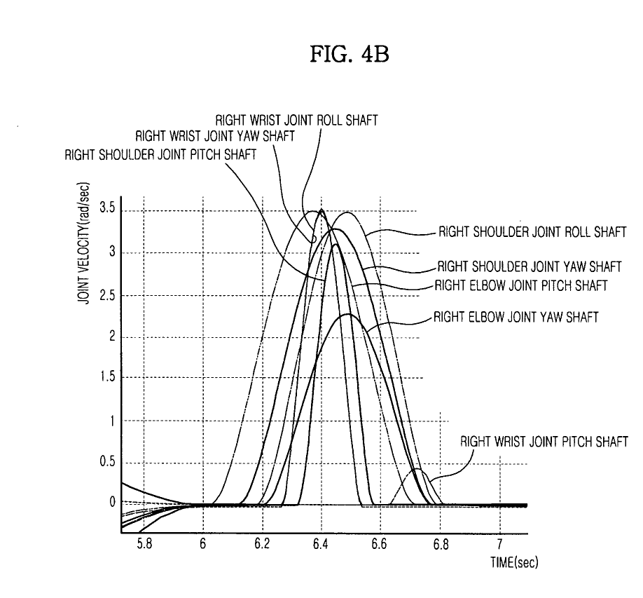

FIG. 4A is a graph illustrating bell-type velocity profiles of arm joints before application of an optimization method only to the arm motions, which are main motions of a commanded throwing action, in the humanoid robot in accordance with at least one embodiment, and FIG. 4B is a graph illustrating bell-type velocity profiles of the arm joints after application of the optimization method only to the arm motions, which are the main motions of the commanded throwing action, in the humanoid robot in accordance with at least one embodiment.

In the case of an action of throwing a ball by the humanoid robot 100, the ball is thrown in a desired direction using the right shoulder joint roll shaft 8R, the right shoulder joint pitch shaft 9R, the right shoulder joint yaw shaft 10R, the right elbow joint yaw shaft 12R, the right elbow joint pitch shaft 11R, the right wrist joint roll shaft 13R, the right wrist joint pitch shaft 14R, and the right wrist joint yaw shaft 15R.

As shown in FIG. 4A, the control unit 210 represents velocity profiles of joints of arms necessary to perform the throwing action through parameterization using parameters representing start times and end times of respective motions of the joints. FIG. 4A represents velocity profiles of the arm joints before the optimization of the arm motions, and shows that start times and end times of the respective joints are equal and the maximum values of angles, velocities, and accelerations of the respective joints are different. A function of an acceleration profile may be generated by performing differentiation of a function of a bell-type velocity profile, and a function of a joint angle profile may be generated by performing integration of a function of a velocity profile.

As shown in FIG. 4B, the control unit 210 represents velocity profiles of joints of arms necessary to perform the throwing action through parameterization using parameters representing start times and end times of respective motions of the joints. FIG. 4B represents velocity profiles optimizing motions of the arm joints to induce the maximum dynamic performing capacity of the robot 100. When the robot 100 performs the throwing action, energy and momentum transfer from the heavy shoulder joint to the end-effector, i.e., the fingertip, is achieved while minimizing energy loss, and thus, the fingertip achieves the maximum velocity at the proper timing.

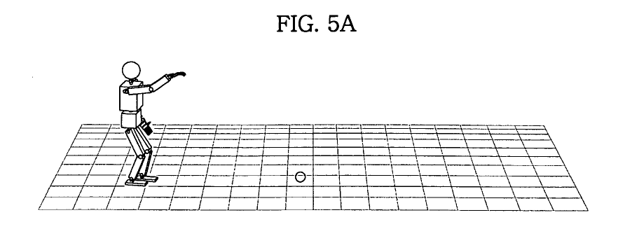

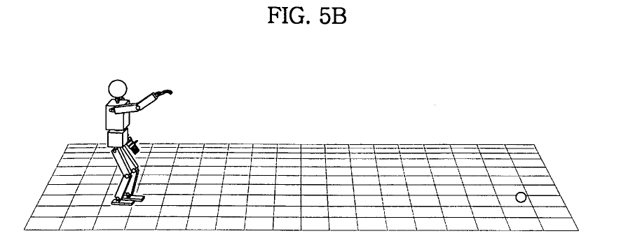

FIG. 5A illustrates the throwing action before application of the motion optimization method to the humanoid robot in accordance with at least one embodiment, and FIG. 5B illustrates the throwing action after application of the motion optimization method to the humanoid robot in accordance with at least one embodiment.

As shown in FIGS. 5A and 5B, when the joint control input timing of the humanoid robot 100 is optimized, the maximum dynamic performing capacity of the humanoid robot 100 provided with actuators having limited sizes is drawn, and thus the ball may be thrown more distantly.

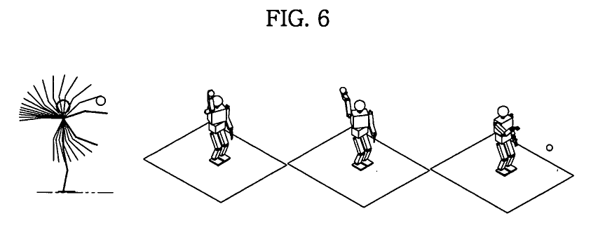

FIG. 6 is a view illustrating continuous actions obtained by applying the optimization method only to the arm motions, which are the main motions of an action of throwing a ball, in the humanoid robot in accordance with at least one embodiment.

As shown in FIG. 6, if the humanoid robot 100 performs an action of throwing a ball, in order for the humanoid robot 100 to throw the ball at the maximum velocity, the shoulder joint 8, 9, and 10 moves, the elbow joint 11 and 12 moves, and then the wrist joint 13, 14, and 15 moves sequentially, and thus joint actuation is carried out at the optimized timing. Here, the remaining parts of the humanoid robot 100 move along motion trajectories predetermined corresponding to the throwing action. When the respective joints of the arm of the humanoid robot 100 sequentially move along motion trajectories optimized to perform arm motions, which are the main motions of the throwing action, energy and momentum transfer from the shoulder to the fingertip is achieved while minimizing energy loss, and thus, the end-effector (for example, the fingertip) may achieve the maximum velocity at the proper timing. Further, optimization of whole body motions of the humanoid robot 100 may be simplified and the action of the humanoid robot 100 may become maximally similar to a real human action.

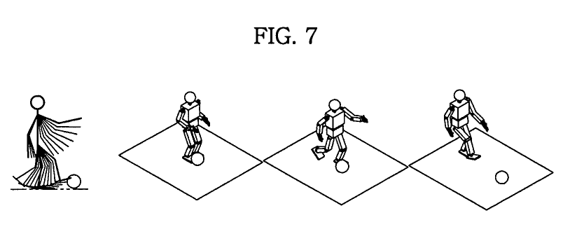

FIG. 7 is a view illustrating continuous actions obtained by applying the optimization method only to leg motions, which are main motions of an action of kicking a ball, in the humanoid robot in accordance with at least one embodiment.

As shown in FIG. 7, if the humanoid robot 100 performs an action of kicking a ball, in order for the humanoid robot 100 to kick the ball at the maximum velocity, the leg joint 16, 17, and 18 moves, the knee joint 19 moves, and then the ankle joint 20 and 21 moves sequentially, and thus joint actuation is carried out at the optimized timing. Here, the remaining parts of the humanoid robot 100 move along motion trajectories predetermined corresponding to the kicking action. When the respective joints of the leg of the humanoid robot 100 sequentially move along motion trajectories optimized to perform leg motions, which are the main motions of the kicking action, energy and momentum transfer from the knee to the toe tip is achieved while minimizing energy loss, and thus, the end-effector (for example, the toe tip) may achieve the maximum velocity at the proper timing. Further, optimization of whole body motions of the humanoid robot 100 may be simplified and the action of the humanoid robot 100 may become maximally similar to a real human action.

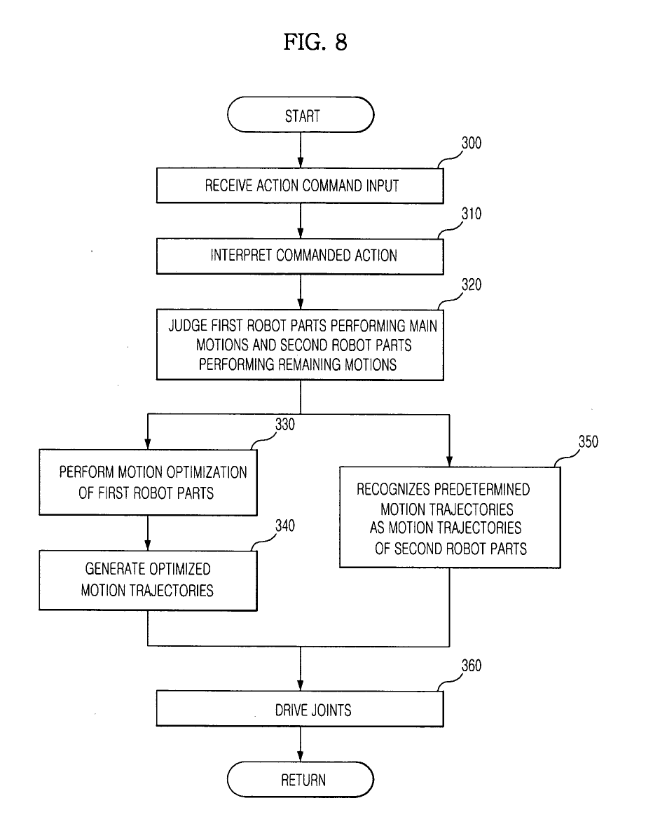

FIG. 8 is a flow chart illustrating a control method of the humanoid robot in accordance with at least one embodiment.

With reference to FIG. 8, the humanoid robot 100 first receives an action command input by a user through the input unit 200 (operation 300).

When the humanoid robot 100 receives the action command, the control unit 210 interprets the user's action command through the command interpretation unit 211 (operation 310), and judges first robot parts (for example, the arms in the throwing action) performing main motions having high relevance with respect to the action commanded by the user and second robot parts (for example, the torso, the legs, etc. in the throwing action) performing remaining motions having low relevance with respect to the commanded action (operation 320). Here, the storage unit 213 divisionally stores first robot parts performing main motions having high relevance with respect to each of actions to be commanded and second robot parts performing remaining motions having low relevance with respect to each of actions to be commanded according to action commands.

Motion optimization as to the first robot parts performing the main motions is performed (operation 330), and optimized motion trajectories are generated according to the motion optimization (operation 340).

Simultaneously, predetermined motion trajectories corresponding to the commanded action are recognized as motion trajectories of the second robot parts performing the remaining motions (operation 350). Here, the storage unit 213 stores predetermined motion trajectories corresponding to action commands.

When the optimized motion trajectories of the first robot parts and the motion trajectories of the second robot parts are set, the control unit 210 controls the driving unit 220, such that the corresponding robot parts move along the respective motion trajectories, and thus drives the joints of the corresponding robot parts along the respective motion trajectories (operation 360).

As is apparent from the above description, in a humanoid robot in accordance with at least one embodiment, if the humanoid robot performs an action of throwing a ball, motion optimization in consideration of robot dynamics is performed only as to the arms, and thus motion trajectories are generated and applied to the arms, and predetermined motion trajectories corresponding to the throwing action are applied to remaining robot parts, such as the legs, the waist, and the torso. Therefore, since motion trajectories only as to the arm motions, which are main motions of the throwing action, are generated in consideration of robot dynamics by repeatedly varying parameters so that the throwing action is similar to a real human action, optimization of whole body motions of the humanoid robot may be simplified and the action of the humanoid robot may become maximally similar to the real human action.

Further, if the humanoid robot performs an action of kicking a ball, motion optimization in consideration of robot dynamics is performed only as to the legs and thus motion trajectories are generated and applied to the legs, and predetermined motion trajectories corresponding to the kicking action are applied to remaining robot parts, such as the arms and the torso. Therefore, since motion trajectories only as to the leg motions, which are main motions of the kicking action, are generated in consideration of robot dynamics by repeatedly varying parameters so that the kicking action is similar to a real human action, optimization of whole body motions of the humanoid robot may be simplified and the action of the humanoid robot may become maximally similar to the real human action.

The control unit may be incorporated into or utilize a processor and at least one of the input unit, the command interpretation unit, the motion trajectory generation unit, and the motion command unit may use the processor to perform each of their respective operations.

Although at least one embodiment has been shown and described, it would be appreciated by those skilled in the art that changes may be made in the at least one embodiment without departing from the principles and spirit of the invention, the scope of which is defined in the claims and their equivalents.

What is claimed is:

1. A humanoid robot comprising:
an input unit to receive an action command input from a user;
a control unit to generate a first control signal to control robot parts performing main motions of a commanded action according to the action command input through the input unit using optimized motion trajectories generated through motion optimization in consideration of robot dynamics, and to generate a second control signal to control robot parts performing remaining motions using predetermined motion trajectories corresponding to the commanded action; and
a driving unit to drive respective joints of the humanoid robot according to the first and second control signals of the control unit.

2. The humanoid robot according to claim 1, wherein each of the robot parts is any one of joints, links, and end-effectors, or combinations thereof.

3. The humanoid robot according to claim 2, wherein each of the motion trajectories is at least one of joint trajectories, link trajectories, and end-effector trajectories.

4. The humanoid robot according to claim 2, wherein the control unit includes a command interpretation unit to interpret the action command input through the input unit and to determine the robot parts performing the main motions having high relevance with respect to the commanded action and the robot parts performing remaining motions having low relevance with respect to the commanded action, respectively.

5. The humanoid robot according to claim 4, wherein the control unit further includes a motion trajectory generation unit to perform optimization as to the robot parts performing the main motions in consideration of robot dynamics to generate the optimized motion trajectories of the robot parts performing the main motions, and to generate the predetermined motion trajectories of the robot parts performing the remaining motions corresponding to the commanded action.

6. The humanoid robot according to claim 5, wherein the control unit further includes a storage unit to divisionally store robot parts performing main motions having high relevance with respect to each of a plurality of actions to be commanded and robot parts performing remaining motions having low relevance with respect to each of the actions to be commanded according to action commands, and to store predetermined motion trajectories corresponding to the action commands.

7. The humanoid robot according to claim 6, wherein the control unit further includes a motion command unit to output a first motion command for the robot parts performing the main motions to move along the optimized motion trajectories, generated by the motion trajectory generation unit, to the driving unit to control operation of the driving unit, and to output a second motion command for the robot parts performing the remaining motions to move along the predetermined motion trajectories, generated by the motion trajectory generation unit corresponding to the commanded action, to the driving unit to control operation of the driving unit.

8. The humanoid robot according to claim 1, wherein the control unit performs the motion optimization by searching for optimum motion trajectories while repeatedly varying motion parameters in consideration of robot dynamics as to the robot parts performing the main motions.

9. The humanoid robot according to claim 8, wherein the joints to perform the main motion of the commanded action and a velocity profile of a center of gravity of the humanoid robot are parameterized using parameters representing a start time and an end time.

10. The humanoid robot according to claim 1, wherein the optimized motion trajectories are generated by optimizing angles, velocities and accelerations of respective joints used in performing main motions of the commanded action so as to generate a maximum velocity of an end-effector.

11. A control method for a humanoid robot, the method comprising:
receiving an action command input from a user;
interpreting the input action command, and determining first robot parts performing main motions of a commanded action and second robot parts performing remaining motions of the commanded action; and
controlling the first robot parts using optimized motion trajectories generated through motion optimization in consideration of robot dynamics, and controlling the second robot parts performing the remaining motions using predetermined motion trajectories corresponding to the commanded action.

12. The control method according to claim 11, wherein each of the first robot parts and the second robot parts is any one of joints, links, and end-effectors, or combinations thereof.

13. The control method according to claim 12, wherein the determining is achieved by analyzing first robot parts and second robot parts which are divisionally stored in advance according to a plurality of action commands.

14. The control method according to claim 13, wherein the predetermined motion trajectories are stored in advance so as to correspond to the commanded action according to action commands.

15. The control method according to claim 11, wherein the motion optimization is performed by searching for optimum motion trajectories while repeatedly varying motion parameters in consideration of robot dynamics as to the first robot parts.

16. The control method according to claim 15, wherein the joints to perform the main motion of the commanded action and a velocity profile of a center of gravity of the humanoid robot are parameterized using parameters representing a start time and an end time.

17. The control method according to claim 11, wherein the optimized motion trajectories are generated by optimizing angles, velocities and accelerations of respective joints used in performing main motions of the commanded action so as to generate a maximum velocity of an end-effector.

18. A humanoid robot, comprising:
an input unit to receive an action command input from a user;
a controller comprising:
a command interpretation unit interpreting the action command input to the input unit and determining robot parts performing main motions having a high relevance compared with all motions of the robot with respect to the commanded action and robot parts performing remaining motions having a low relevance compared with all motions of the robot with respect to the commanded action,
a motion trajectory generation unit generating optimized motion trajectories of the robot parts performing the main motions and generating predetermined motion trajectories of the robot parts performing the remaining motions, and
a motion command unit outputting a first motion command for the robot parts performing the main motions to move along the optimized motion trajectories and second motion command for the robot parts performing the remaining motion to move along the predetermined motion trajectories; and
a driving unit receiving the first and second motion commands and driving respective joints of the humanoid robot according to the first and second motion commands.

19. A control method for a robot, comprising:
receiving an action command input from a user;
interpreting the action command input to the input unit and determining robot parts performing main motions having a high relevance compared with all motions of the robot with respect to the commanded action and robot parts performing remaining motions having a low relevance compared with all motions of the robot with respect to the commanded action;
generating optimized motion trajectories through motion optimization in consideration of robot dynamics for the robot parts determined to perform the main motions;
accessing a storage unit to obtain predetermined motion trajectories stored in advance for the robot parts determined to perform the remaining motion; and
driving respective joints of the robot according to the optimized motion trajectories and the predetermined motion trajectories.
